(19) United States
(12) Patent Application Publication
(10) Pub. No.: US 2017/0328391 A1
(43) Pub. Date: Nov. 16, 2017

(54) AUTOMATIC PAYLOAD DELIVERY FOR A FLYING DRONE

(71) Applicant: Hari Matsuda, Nevada City, CA (US)

(72) Inventor: Hari Matsuda, Nevada City, CA (US)

(21) Appl. No.: 15/636,236

(22) Filed: Jun. 28, 2017

Related U.S. Application Data
(63) Continuation-in-part of application No. 14/583,388, filed on Dec. 26, 2014, now Pat. No. 9,714,087.
(60) Provisional application No. 61/975,784, filed on Apr. 5, 2014.

(51) Int. Cl. F16B 2/22; B64C 39/02

(52) U.S. Cl. CPC F16B 2/22; B64C 2201/128; B64C 39/024; B64C 2201/042

(57) ABSTRACT

A drone delivered package-to-receiver coupler is described, with a rear portion configured with one or more package attachment surface(s), with support arms extending towards a front of the coupler, being separated from each other to form a gap between them. The coupler contains a living hinge portion spanning the gap and coupled to the support arms, with a pivoting section that translates to open/closed positions, restrained by the support arms. A coupler portion is connected to at least one of the support arms and living hinge, with capture arms extending to the front of the coupler that swing open/close when the pivoting section of the living hinge is translated. Therefore, when a rod or arm is coupled to, it is substantially encompassed by the capture arms and the living hinge, so that the package-to-receiver coupler can slide along the rod or arm in the closed position.

### CROSS-REFERENCE TO RELATED APPLICATION(S)

This application is a continuation-in-part of and claims benefit of U.S. patent application Ser. No. 14/583,388, filed Dec. 26, 2014, titled “Winged Multi-Rotor Flying Craft With Payload Accommodating Shifting Structure And Automatic Payload Delivery,” the contents of which are hereby incorporated by reference in their entirety.

### FIELD

This invention relates to delivery systems and sub-systems for drone aircraft. More particularly, to payload attachment and detachment systems for automated drone payload delivery and/or exchange.

### BACKGROUND

The increasing popularity of drone aircraft has solicited the attention of businesses, particularly for the possibility of in-flight delivery of payloads or packages to a customer. The typical delivery scenario contemplated by businesses or other entities requires complicated package “control” mechanisms, all of which substantially increase the weight of the drone/package and thereby reduces the performance/delivery metrics. Accordingly, what is needed in the industry is a simple but elegant solution for payload attachment and detachment, as well as supporting customer friendly receiving stations. Various such systems and methods are described below.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of the disclosed embodiments, a package-to-receiver coupler is provided, comprising: a rear portion configured with one or more surfaces for attachment to a package, with support arms extending from the rear portion towards a front of the coupler, the support arms being separated from each other to form a gap between them; a living hinge portion spanning the gap and coupled to the support arms, the living hinge having a pivoting section that translates to an open position and a closed position, being held in the respective positions by force from the support arms; and a coupler portion connected to at least one of the support arms and living hinge, having capture arms extending to the front of the coupler that swing open or close when the pivoting section of the living hinge is translated, wherein a rod or arm being coupled to, is substantially encompassed by the capture arms and the living hinge, and wherein the package-to-receiver coupler can slide along the rod or arm in the closed position.

In another aspect of the disclosed embodiments, the above package-to-receiver coupler is provided, further comprising an inward directed elbow at an end of the capture arms; and/or wherein the support arms are in the shape of at an arc; and/or wherein the one or more rear portion surfaces extend laterally and are separated from each other; and/or wherein the package-to-receiver coupler is fabricated from a single material; and/or wherein the living hinge's pivoting section is formed from a plastic material; and/or wherein the living hinge's pivoting section is formed via a perforation of the pivoting section or a thinning of the pivoting section; and/or wherein the package-to-receiver coupler is formed from at least one of an injection molded, formed, cast, 3-D printed process; and/or further comprising a package attached to the rear portion; and/or comprising a package release mechanism comprising: a pivoting paddle with an upper portion coupled to a pivot and a lower portion coupled to the pivot, the upper portion being angled in a elevated orientation away from the package when in an un-release mode and angled in an orientation substantially planar with the lower portion when in a release mode, the lower portion being attached to the package; a swing arm coupled to the upper portion and extending downward over the lower portion, having a lateral extension at its terminal end, the lateral extension moving with the swing arm so, when in a un-release mode, is blocked by a tab of package retainer and, when in a release mode, is not blocked from the tab, allowing the package to exit the package retainer; and/or wherein the pivoting paddle has a plurality of swing arms; and/or wherein the package retainer has a plurality of tabs; and/or wherein the package retainer has retentions arms; and/or wherein the lateral extension forms a hollow U-shaped cavity, configured to fit over the package retainer's tab; and/or wherein the package is attached to a drone; and/or wherein the package is a battery for powering the drone; and/or wherein the package is at least one of a life vest and survival gear.

### BRIEF DESCRIPTION OF THE DRAWINGS

FIG. 1A is an abstract two-part illustration showing a delivery drone in the process of delivering a payload to a destination/delivery site receiver arm.

FIG. 1B is an illustration of a receiver station that is situated on a mobile platform.

FIG. 2 is an illustration of payload with a close up view of single attached receiver coupler and drone payload retainer.

FIG. 3A is an illustration of a cross-sectional structural view of the receiver coupler in proximity to a receiver arm.

FIG. 3B is an illustration of the embodiment of FIG. 3A in a “locked” position.

FIG. 4A is an illustration of pivoting release mechanism that is attachable to a payload.

FIG. 4B is a closeup illustration of payload retainer tabs that protrude from a payload retainer end, and is understood to be self-explanatory.

FIG. 5A shows a design similar to that shown in FIG. 4A, with pivot section and paddle.

FIG. 5B is a side view showing the payload release mechanism in a “locked” position with cavity of guide arm ends, extending via guide arms

FIG. 5C is a side view showing the “unlocked” position of payload release mechanism's guide arm ends from retainer tab(s) when paddle is pressed closer to the payload's face.

FIG. 6 is an illustration of another payload retainer with payload retainer arms and payload retainer tabs.

### DETAILED DESCRIPTION

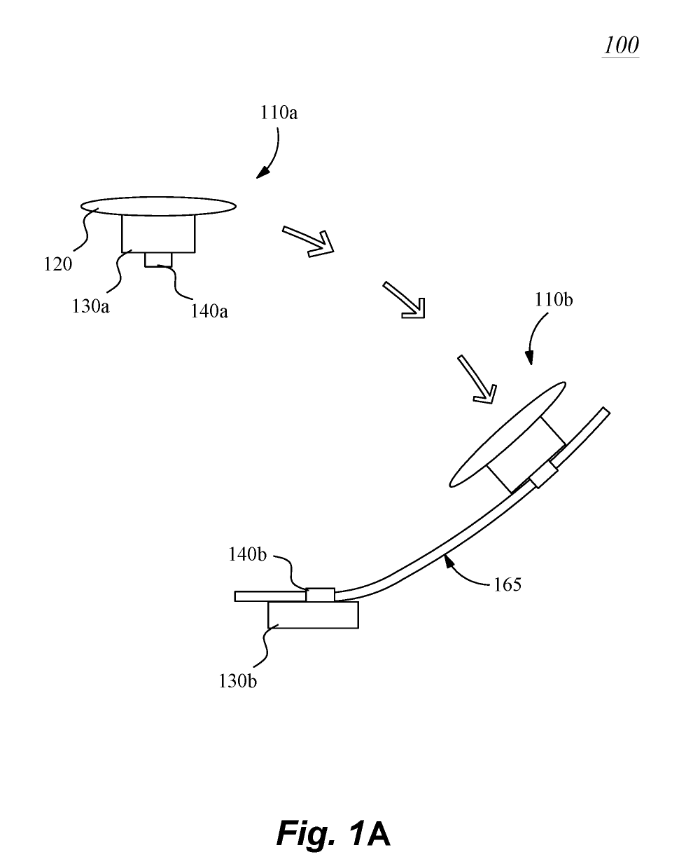

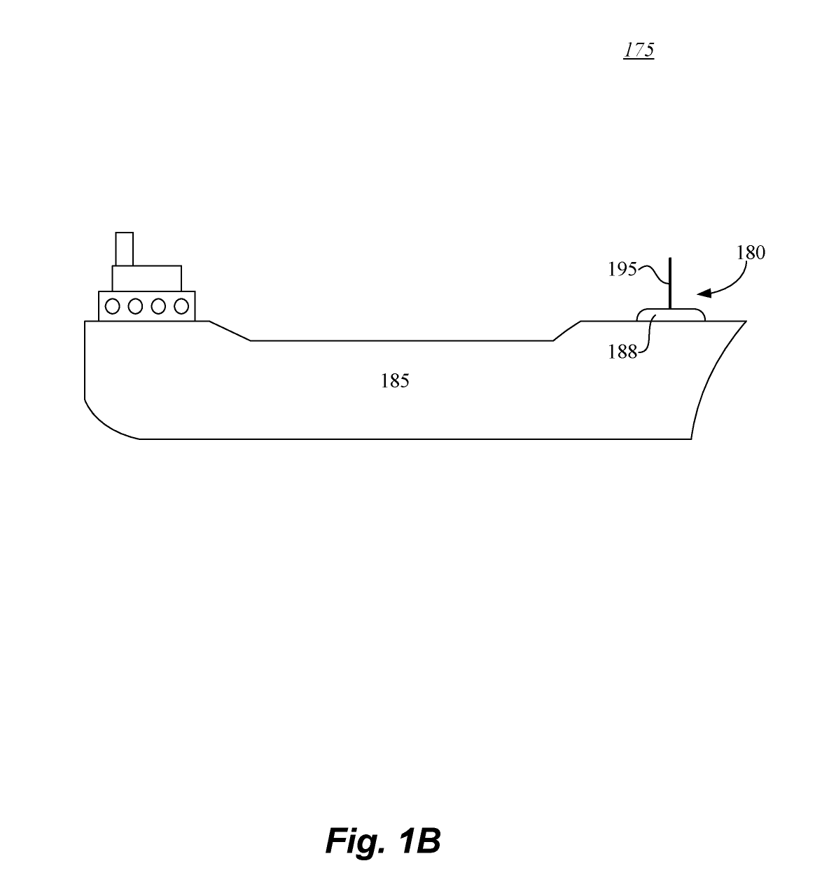

FIG. 1A is an abstract two-part illustration 100 showing a delivery drone 120 in the process of delivering a payload 130a to a destination/delivery site receiver arm 165. 110a is the drone 120 in flight with payload 130a and receiver coupler 140a attached to a side of the payload 130a. The receiver coupler 140a facilitates coupling to the receiver arm 165 as shown in 110b, and may be on the bottom of the payload 130a or a side, top, etc., thereof. The receiver coupler 140a is designed to allow it to be “captured” by an arm 165 of a package receiver station (not shown) and, in some embodiments, slide down the arm 165 to a resting position, as seen at the lower end of the arm 165 with another pre-delivered payload 130b and attendant receiver coupler 140b.

It should be appreciated that FIG. 1A demonstrates the use of a receiver arm 165 that operates to retain released payloads and, in some embodiments, directs such released payloads to a different part of the arm 165. A benefit of such an arm configured to a separately located receiver station is that the drone does not need to fly into a congested space, or enter into the customer's premises (this is apropos for privacy and safety concerns) to deliver its payload. Depending on the customer's receiver station location, the arm 165 may extend upward and/or outward, for example from a customer's balcony, roof, room window, etc. In these situations, the receiver station may actually be located within the customer's premises while the arm 165 is external thereto. Of course, in some embodiments both the arm 165 and receiver station may be co-located.

It should be appreciated that the arm 165 may have different shapes, may be multi-armed, and may, if so configured, have different “resting” positions along an arm, for example, as an elongated stair step. Additionally, in some embodiments, the arm 165 may be fully upwardly directed (e.g., a pole) or horizontally directed (horizontal pole) and/or telescoping, so as to allow a customer to retrieve the delivered payload from the “end” of the arm 165. Thus, it should be apparent to one of ordinary skill that, given the disclosure provided, various modifications and changes may be made to the arrangement shown in FIG. 1A without departing from the spirit and scope of this disclosure.

FIG. 1B is an illustration 175 of a receiver station 180 that is situated on a mobile platform 185, for example, on a ship or vehicle. This embodiment contemplates the use of a stabilization mechanism 188 to steady the arm 195 to allow the delivery drone (not shown) to affix/release its package onto the arm 195. This embodiment is particularly relevant for ship going deliveries or for military/rescue operations where the drone is a surveillance or rescue drone. Here, the movement of the sea will rock the arm 195 making it difficult, if not impossible, for the drone to “release” the package onto the arm 195. Therefore, some stabilization mechanism is implemented. One approach is through the use of gimbals. Alternative approaches may use electric motors to move the receiver station 180 and/or arm 195 with motion sensors. Of course, these and other approaches are well known in the art and therefore are not elaborated herein. Accordingly, such systems are understood to be within the purview of one of ordinary skill in the art.

It should be understood that the package to be delivered may actually be a battery/power cell for powering the drone itself, being exchanged for a “fresh” battery/power cell. Or, the package could be any released item. For example, in a rescue scenario, the package could be a life vest, small inflatable boat, flares, food, etc. that could independently deployed by some operator-initiated trigger or set condition at the remote/non-receiver station site.

It should be appreciated that while the example shown in FIG. 1B is for a ship, it is expressly understood other moving vehicles/vessels may benefit from a “motion-stabilized” receiver station/arm. In some embodiments, a camera may be part of the drone system, thereby enabling an operator to remotely-control various operational features, such as, for example, deployment, flares, life vests, etc.

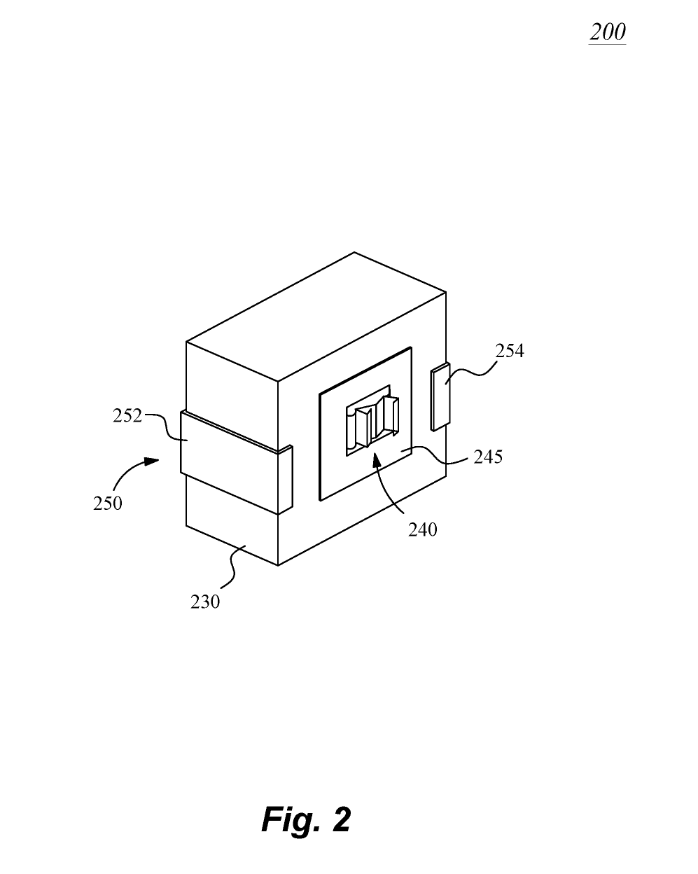

FIG. 2 is an illustration 200 of payload 230 with a close up view of single attached receiver coupler 240 and drone payload retainer 250. Drone payload retainer 250 operates to “secure” the payload 230 to the drone (not shown), and is shown here as two simple encompassing arms 252, 254. Of course, other payload retainer configurations and designs may be used, which are understood to be within the purview of one of ordinary skill in the art. For example, a plurality of sets of encompassing arms may be used, or an orientation thereof is different than shown. Additionally, one or more encompassing arms may be situated at different locations than shown.

The receiver coupler 240 can be affixed to the payload 230 by any number of ways, for example via an adhesive applied to the frame 245 of the receiver coupler 240. Or, the payload exterior may have a “mating” area designated for the receiver coupler 240. Various configurations and methods for attaching a mechanism (such as the receiver coupler 240) to a surface are well known in the art and therefore, not elucidated herein.

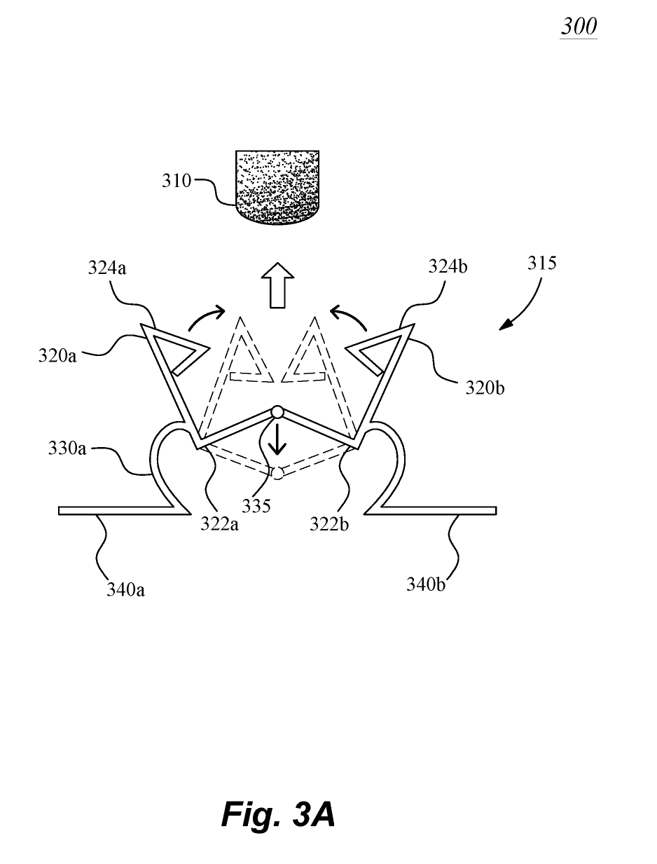

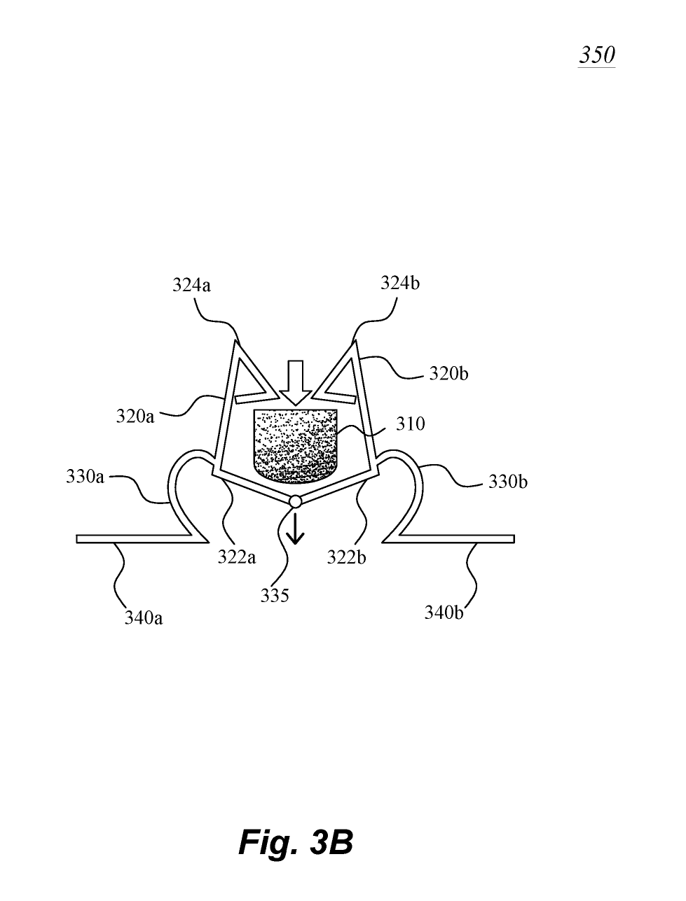

FIG. 3A is an illustration 300 of a cross-sectional structural view of the receiver coupler 315 in proximity to a receiver arm 310. The exemplary receiver coupler 315 is comprised of two or more outwardly extending capture arms 320a,b with inner legs 322a,b that are joined at a hinged or flexible pivot 335. The flexible pivot 335 is sometimes called in the art as a living hinge—providing an axis of flexure, and can be entirely made of the same material the receiver coupler 315 is made of, or made of a different material. For military uses, the flexible pivot 335 may be made of metal, silicone, and/or be a physical hinge, with interlocking pieces that swivel. If made of the same material as the receiver coupler 315, the flexible pivot 335 can be made via puncturing or perforating pieces of the flexible pivot 335 along its axis or “thinning” the axis to allow for easier bending. Alternative designs for the flexible pivot 335 are available in the art and therefore not further elaborated herein.

The living hinge design allows the receiver coupler 315 to “couple” to receiver arm 310 and also, upon application of sufficient “opening” force, presumably by the customer, be released from the receiver coupler 31. Thus “capture” of the payload can be effected by the drone delivery process and the payload can be retrieved by the customer pulling the payload off the receiver arm.

In view of the scenario being contemplated, it should be understood that in various embodiments, the receiver coupler 315 may be fabricated from inexpensive material(s), so as to provide a “disposable” or one/limited-time use device. Depending on the material used and the final design/configuration complexity, the receiver coupler 315 can be fabricated for pennies or even less.

The ends of the capture arms 320a,b are configured with retention elbows 324a,b which operate to “close” around the receiver arm 310, when the receiver coupler 315 is engaged. The solid rendering for the capture arms, inner legs, and retention elbows show a pre-release arrangement of the receiver coupler 340, evidenced with its “mouth” being open for engaging the receiver arm 310. The dashed rendering show the arrangement when the receiver coupler 340 is moved (upward pointing arrow) towards the receiving arm 310 which will press against one or more inner legs 322a,b to force the capture arms 320a,b to pivot inward around the “rear” of the receiver arm 310. Thus, the capture arms 320a,b in combination with the retention elbows 324a,b operate to encase the receiver coupler 315 around the receiver arm 310. Elements 340a,b are planar surface extensions that brace the support arms 320a,b.

In various embodiments, the receiver arm 310 may be shaped with a blunt rearward surface to make it more difficult for it apply “opening” pressure against the retention elbows 324a,b. Additionally, along this line of reasoning, the receiver arm 310 may also have a curved or “pointed” forward end, to allow easier fitment into the open capture arms 320a,b. Of course, these are optional and the ultimate shape of the receiver arm 310 may be different than shown, for example a simple circular rod may suffice.

Extensions 340a,b can be attachment surfaces to an underlying payload surface or coupler assembly to the payload (not shown). These extensions 340a,b may be glued to the payload surface, having, for example, an adhesive backing, or slipped under/into retention bands or folds (not shown) in the payload. As should be evident, the extensions 340a,b may also fully extend from one end of the receiver coupler 315 to the other end, thus increasing the surface area for contact with the payload. Thus, given the various approaches for “attaching” the extensions 340a,b to the payload, it is fully understood that any other design useable for “attaching” the receiver coupler 315 may be implemented without departing from the spirit and scope of this disclosure.

The rotation of the capture arms 320a,b against the resilient support arms 330a,b can be configured to cause a detent-like action to occur. For example, in this embodiment the support arms 330a,b act to provide a degree of resistance against straightening of the inner legs 322a,b. However, if sufficient force is exerted on the inner legs 322a,b, the support arms 330a,b can be made of a material that is resilient so as permit outward bending. In this example, the pressing of the receiver arm 310 forces “straightening” of the inner legs 322a,b against the support arms 330a,b, which allow the inner legs 322a,b to pivot and collapse “inwardly and be “locked” from release. The amount of force required to cause this action is generally, but not necessarily, a function of one or more of the support arms' shape, material composition, length, position, etc. Therefore, it is expressly understood that while FIG. 3A shows the support arms having a half-heart like shape, other shapes, configurations, and so forth can be utilized, according to design preference. For example, the support arms may not be a singular arm, but a solid mechanism that is resilient to pressure—one non-limiting example would be a foam disc, an exterior surface of which is deformed when pressed, but springs back to form when the pressure is released. Thus, other examples and mechanisms are within the purview of one of ordinary skill in the art and are understood to be within the scope and spirit of this disclosure.

FIG. 3B is an illustration 350 of the embodiment of FIG. 3A in a “locked” position. As discussed above, retention elbows 324a,b are shown now behind receiver arm 310, with pivot 335 in its “engaged” position and inner legs 322a,b swung inward into their “locked” position via tension from support arms 330a,b. It should be understood that the term “locked” in this context does not mean prohibiting release, but simply means a certain degree of force is required to cause release. As can be appreciated, release will be necessary when the customer retrieves the payload, which can be accomplished by pulling the payload (with attached receiver coupler) with sufficient force to overcome the support arms 330a,b tension.

It should be appreciated that the receiver coupler can be injection molded, formed, cast, 3-D printed, and so forth from plastic or similarly inexpensive material and may be designed as a single use or limited use product, if so desired. Thus, a “disposable” or cheap receiver coupler can be devised.

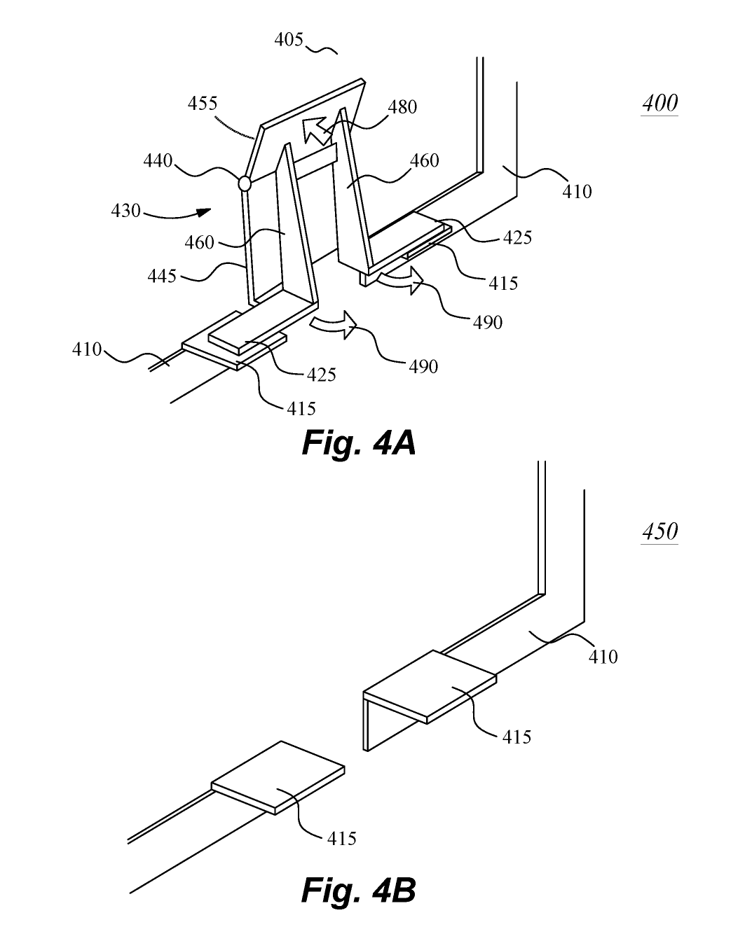

FIG. 4A is an illustration 400 of pivoting release mechanism 430 that is attachable to a payload 405. The pivoting release mechanism 430 can be used for “locking” the payload 405 to the drone's payload retainer structure to prevent release of the payload 405 through the “bottom” of the payload retainer structure. The pivoting release mechanism 430 also controls release of the payload 405 from the drone, especially if payload 405 is vertically oriented as shown here. Specifically, in this embodiment, pivoting release mechanism 430 contains a movable “paddle” 455 joined via pivot joint 440 to plate 445 that is mounted to the payload 405. The plate 445 can be mounted via an adhesive or other securing method, if so desired. The pivot joint 440 may simply be a flexible or “soft” section of the paddle 455, and pre-tensioned (if so desired) to have the orientation of the paddle 455 in a first “locked” position.

Paddle 455 is coupled to guide arms 460 that are spaced far enough from each other to allow a receiver arm (not shown) to fit therebetween. One or more of the ends 425 of the guide arms 460 is flared out and when in the first position (as shown), operate to vertically interfere with payload retainer tabs 415 that protrude from a payload retainer end 410. The position of the guide arm ends 425 prevent the payload 430 from “sliding” down (e.g., from the force of gravity) and out from a payload retainer and therefore acts as a release mechanism when the guide arm ends 425 are raised away from the payload retainer tabs 415.

This operation is evident by arrows 480 (illustrating a “force” exerted by a non-visible retainer arm) on the paddle 455. This causes the paddle 455 to pivot towards the face of the payload 405, which in turn causes the guide arms 460 to elevate away from the face of the payload 405 (and the payload retainer tabs 415), as seen in arrows 490. Via simply the force of gravity (or by action of the drone “lifting” upward), the payload 405 will drop from the bottom of the payload retainer and the entire pivoting release mechanism 430 will slide through the gap between the payload retainer tabs 415. Of course, the directional terms upward and down are subjective, as release of the payload 405 can still occur at other than 90 degree vertical angles. For example, if the drone is in a horizontal position, release of the payload 405 can still occur by the drone providing the horizontal movement to slide the payload 405 from the payload retainer rather than via gravity. Accordingly, while the examples shown herein are in the context of a vertically oriented delivery scenario, other orientations and angles are understood to be feasible and within the purview of this disclosure.

It is understood that the gap and the paddle 455 generally will be substantially in line with the receiver coupler of the previous FIGS., thus a dual-action is achieved by 1) the retainer arm being captured by the receiver coupler, and 2) the retainer arm pushing against the paddle to cause release of the package.

It should be appreciated that the payload release mechanism 430 can be injection molded, formed, cast, 3-D printed, and so forth from plastic or similarly inexpensive material and designed to be single use, if so desired. Further, various portions of the payload release mechanism 430 may be made metal, or of natural materials (e.g., wood, paper, etc.), such as, for example, plate 445 may be cardboard. Also, as can be seen, the release mechanics of this embodiment do not require any electronics and only requires the application of force from of the receiver arm against the paddle 455 to allow the guide arm ends 425 to move and release the payload 405. Thus, the exemplary payload release mechanism 430 can be electronics-fee, if so desired, therefore reducing the costs associated with such systems.

While the releasing system may not require electronics, in some circumstances the docking system (receiver coupler and/or pivoting release mechanism) may have some electronics for guiding the drone for close-in alignment and/or contact confirmation with the receiver arm. In some embodiments, contact with a surface (for example, paddle 455) will indicate to the drone that release is now possible. This can be achieved with a metalized paddle surface and some form of conductivity/current/voltage sensor. On this subject, it is contemplated that the arms 252 (see FIG. 2) of the payload retainer may have electronics for payload-to-receiving arm proximity detection.

FIG. 4B is a closeup illustration 450 of payload retainer tabs 415 that protrude from a payload retainer end 410, and is understood to be self-explanatory.

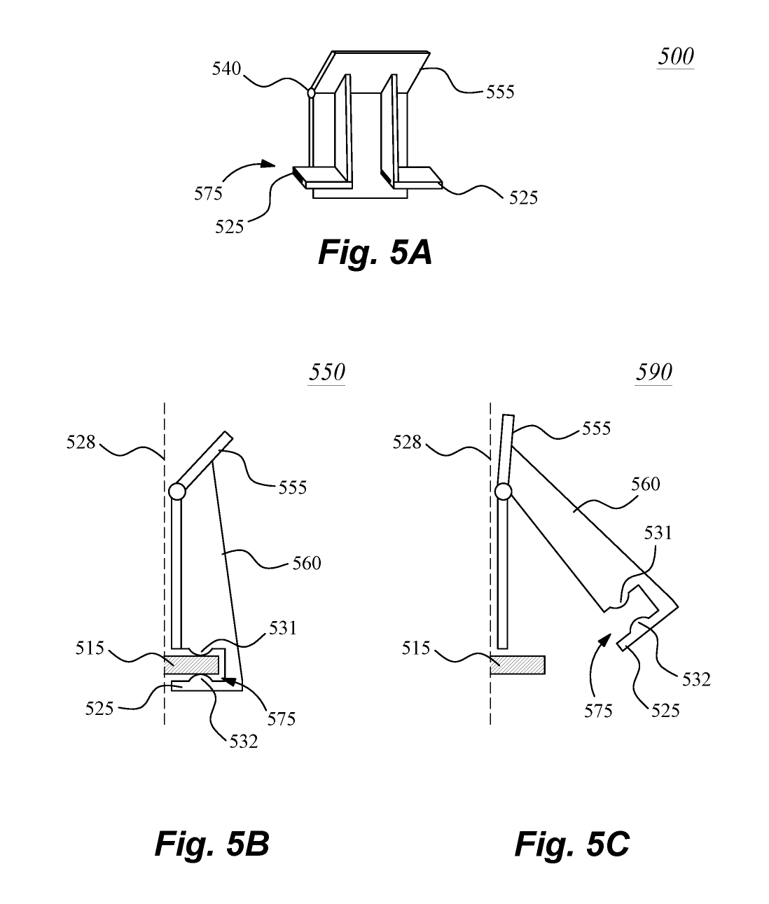

FIGS. 5A-C are illustrations of another embodiment of the payload release mechanism. FIG. 5A shows a design 500 similar to that shown in FIG. 4A, with pivot section 540 and paddle 555. However, guide arm ends 525 are “U-shaped” with an internal cavity 575, so as to provide orientation independent locking. The cavity 575 allows the ends 525 to slip “over” the retainer tabs.

FIG. 5B is a side view 550 showing the payload release mechanism in a “locked” position with cavity 575 of guide arm ends 525, extending via guide arms(s) 560 from paddle 555, encompassing the top and bottom sides of retainer tab 515. Dotted line 528 represents the payload surface wherein the body of the payload release mechanism is affixed thereto, either by a mechanical device or interface or via an adhesive. Optionally shown here are friction bumps 531, 532 or some equivalent thereto in the interior of cavity 575, so as to provide a mechanism to retain the guide arm ends 525 onto the retainer tab 515. For example, properly aligning and mounting the payload release mechanism to a payload at the appropriate retainer tab 515 height can be simply performed by first sliding the cavity 575 section of the guide arm ends 525 over the retainer tabs 515 and pressing the payload release mechanism (having an adhesive, for example) to the payload surface.

The friction bumps 531, 532 can be of sufficient height and of resilient nature to essentially lock the guide arm ends 525 onto the retainer tabs 515. The friction bumps 531, 532 may be integrally formed with the payload release mechanism, if so desired. Of course, while two friction bumps 531, 532 are shown, more or less or different locations can be utilized without departing from the spirit and scope of this disclosure.

FIG. 5C is a side view 590 showing the “unlocked” position of payload release mechanism's guide arm ends 525 from retainer tab(s) 515 when paddle 555 is pressed closer to the payload's face 528. The outwardly swinging of the guide arm ends 525 releases them from the retainer tab(s) 515, thus there is no longer any interaction or blocking mechanism between the payload and the payload retainer holding the payload.

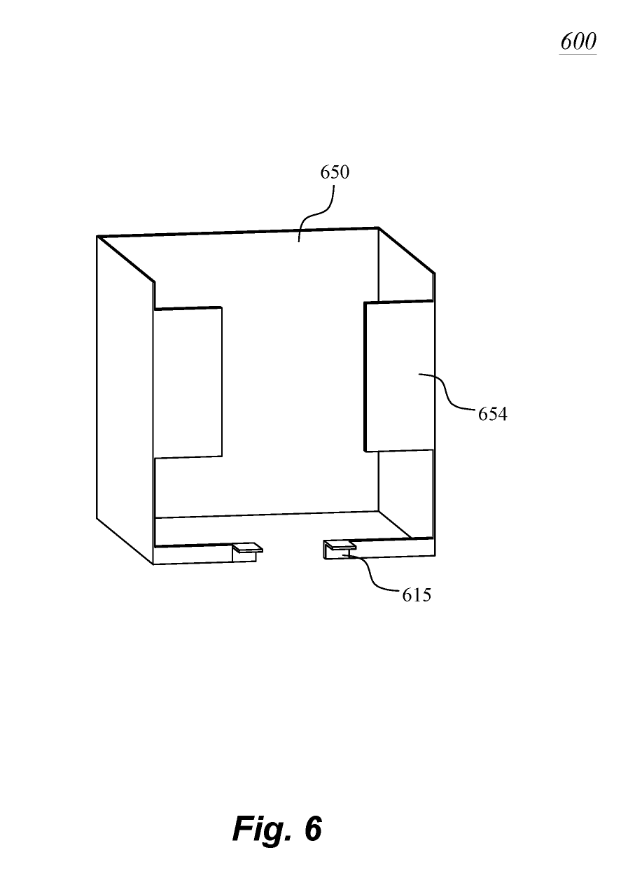

FIG. 6 is an illustration 600 of payload retainer 650 with payload retainer arms 654 and payload retainer tabs 615. The payload retainer 650 allows a released payload to “slide” out from the top or bottom of the payload retainer 650, wherein locking of the payload to the payload retainer 650 is via the retainer tabs 615 and a payload release mechanism (not shown), as described herein. It should be apparent that top or bottom exiting can be further restricted by having a top or bottom end of the payload retainer 650 capped. Thus, in some embodiments, it may be desirable to have only one side for entry and exit for the payload, the closed off entry/exit being capped or stopped via some end protrusion, for example.

It should also be appreciated that the payload retainer 650 may be designed so the retainer tabs 615 are positioned at the top or bottom of the payload retainer arms 654, thus eliminating the extensions at the bottom of the payload retainer. Thus, an embodiment similar to that shown in FIG. 2 can be devised but with retainer tabs 615 placed on the payload retainer arms 654.

It should be expressly understood that the various embodiments described herein may also be applicable to the releasing/locking of a battery pack or a power pack for use by the drone. Thus, various aspects of this disclosure are not limited to payloads or packages but also can be used for releasing, replenishing, etc. drone equipment or sub-systems. For example, it is believed that such a system can be used to off-load batteries into a charging station that is connected to or part of a receiving arm or receiving station. Thus, a drone can be self-maintaining (as it pertains to power replenishment), by releasing a low/expired battery pack (which may automatically slide/be connected to a recharger) and the drone can automatically engage a fully powered power pack for a subsequent mission.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A drone delivered package-to-receiver coupler, comprising:
a rear portion configured with one or more surfaces for attachment to a package, with support arms extending from the rear portion towards a front of the coupler, the support arms being separated from each other to form a gap between them;
a living hinge portion spanning the gap and coupled to the support arms, the living hinge having a pivoting section that translates to an open position and a closed position, being held in the respective positions by force from the support arms; and
a coupler portion connected to at least one of the support arms and living hinge, having capture arms extending to the front of the coupler that swing open or close when the pivoting section of the living hinge is translated,
wherein a rod or arm being coupled to, is substantially encompassed by the capture arms and the living hinge, and wherein the package-to-receiver coupler can slide along the rod or arm in the closed position.

2. The package-to-receiver coupler of claim 1, further comprising an inward directed elbow at an end of the capture arms.

3. The package-to-receiver coupler, wherein the support arms are in the shape of at an arc.

4. The package-to-receiver coupler of claim 1, wherein the one or more rear portion surfaces extend laterally and are separated from each other.

5. The package-to-receiver coupler of claim 1, wherein the package-to-receiver coupler is fabricated from a single material.

6. The package-to-receiver coupler of claim 1, wherein the living hinge's pivoting section is formed from a plastic material.

7. The package-to-receiver coupler of claim 1, wherein the living hinge's pivoting section is formed via a perforation of the pivoting section or a thinning of the pivoting section.

8. The package-to-receiver coupler of claim 1, wherein the package-to-receiver coupler is formed from at least one of an injection molded, formed, cast, 3-D printed process.

9. The package-to-receiver coupler of claim 1, wherein the coupler is a single-use coupler.

10. The package-to-receiver coupler of claim 1, further comprising a package attached to the rear portion.

11. The package-to-receiver coupler of claim 10, further comprising a package release mechanism comprising:
a pivoting paddle with an upper portion coupled to a pivot and a lower portion coupled to the pivot, the upper portion being angled in a elevated orientation away from the package when in an un-release mode and angled in an orientation substantially planar with the lower portion when in a release mode, the lower portion being attached to the package; and
a swing arm coupled to the upper portion and extending downward over the lower portion, having a lateral extension at its terminal end, the lateral extension moving with the swing arm so, when in a un-release mode, is blocked by a tab of package retainer and, when in a release mode, is not blocked from the tab, allowing the package to exit the package retainer.

12. The package-to-receiver coupler of claim 11, wherein the pivoting paddle has a plurality of swing arms.

13. The package-to-receiver coupler of claim 11, wherein the package retainer has a plurality of tabs.

14. The package-to-receiver coupler of claim 11, wherein the package retainer has retentions arms.

15. The package-to-receiver coupler of claim 11, wherein the lateral extension forms a hollow U-shaped cavity, configured to fit over the package retainer's tab.

16. The package-to-receiver coupler of claim 10, wherein the package is attached to a drone.

17. The package-to-receiver coupler of claim 16, wherein the package is a battery for powering the drone.

18. The package-to-receiver coupler of claim 16, wherein the package is at least one of a life vest and survival gear.
